(19) United States
(12) Patent Application Publication
(10) Pub. No.: US 2018/0354751 A1
(43) Pub. Date: Dec. 13, 2018

(54) MACHINE ASSEMBLY AND ELEVATOR

(71) Applicant: Otis Elevator Company, Farmington, CT (US)

(72) Inventor: Jian Chen, Shanghai (CN)

(21) Appl. No.: 16/001,162

(22) Filed: Jun. 6, 2018

(30) Foreign Application Priority Data
Jun. 7, 2017 (CN) 201710422518.8

(51) Int. Cl. B66B 7/04; B66B 7/02; B66B 1/36

(52) U.S. Cl. CPC B66B 7/044; B66B 7/02; H01F 7/0231; B66B 7/047; B66B 1/36

(57) ABSTRACT

An electromagnetic guide assembly, an elevator and a control method thereof. The electromagnetic guide assembly includes a first magnetic element for connecting to an elevator car and a second magnetic element for connecting to an elevator liftway; wherein the electromagnetic guide assembly comprises two states. In a first state, the first magnetic element and the second magnetic element abut against each other; and in a second state, the first magnetic element and the second magnetic element are separated from each other, and the first magnetic element and the second magnetic element are capable of generating a relative movement along the longitudinal direction of the elevator liftway.

### FOREIGN PRIORITY

This application claims priority to Chinese Patent Application No. 201710422518.8, Jun. 7, 2017, and all the benefits accruing therefrom under 35 U.S.C. § 119, the contents of which in its entirety are herein incorporated by reference.

### TECHNICAL FIELD

The present invention relates to the field of elevators, and more specifically, to an electromagnetic guide assembly for an elevator and a method for controlling an elevator.

### BACKGROUND ART

Elevators have become an indispensable vehicle in daily life, which are usually used for the transfer and transportation of people in large buildings. At present, during operation of an elevator, noise and vibration generated by the elevator car greatly affect passengers' experience. These noise and vibration are usually caused by contact and friction between the guide shoe of the elevator car and the guide rail inside the liftway. In addition, when passengers enter or exit an elevator, due to the cooperative relationship between the guide rail and the guide shoe, a certain oscillation is usually generated, which also affects passengers' experience very much. Furthermore, as there is a direct frictional relationship between the guide rail and the guide shoe, to ensure the performance of the system and to improve safety, it is necessary to periodically inject lubricating oils and test, which will cost a lot of manpower and material resources.

### SUMMARY OF THE INVENTION

An object of the present invention is to provide an electromagnetic guide assembly for elevator guidance.

Another object of the present invention is to provide an elevator having an electromagnetic guide assembly.

Yet another object of the present invention is to provide a method for controlling an elevator having an electromagnetic guide assembly.

To achieve the object of the present invention, according to one aspect, there is provided an electromagnetic guide assembly, which includes: a first magnetic element for connecting to an elevator car; and a second magnetic element for connecting to an elevator liftway; wherein the electromagnetic guide assembly comprises two states: in a first state, the first magnetic element and the second magnetic element abut against each other; in a second state, the first magnetic element and the second magnetic element are separated from each other, and the first magnetic element and the second magnetic element are capable of generating a relative movement along the longitudinal direction of the elevator liftway.

To achieve another object of the present invention, according to another aspect, there is also provided an elevator, which includes: an elevator liftway; an elevator car, which is arranged in the elevator liftway; and an electromagnetic guide assembly, which includes a first magnetic element for connecting to the elevator car and a second magnetic element for connecting to the elevator liftway; wherein the electromagnetic guide assembly comprises two states: in a first state, the first magnetic element and the second magnetic element abut against each other, at which time the elevator car is stationary with respect to the elevator liftway; and in a second state, the first magnetic element and the second magnetic element are separated from each other, at which time the elevator car and the elevator liftway are capable of generating a relative movement along the longitudinal direction of the elevator liftway.

To achieve yet another object of the present invention, according to yet another aspect, there is also provided a method for controlling an elevator, the elevator includes an elevator liftway, an elevator car, and an electromagnetic guide assembly. The electromagnetic guide assembly includes a first magnetic element for connecting to the elevator car and a second magnetic element for connecting to the elevator liftway; wherein when the elevator car is stopped, the electromagnetic guide assembly is controlled to be in a first state, at which time the first magnetic element and the second magnetic element abut against each other; and when the elevator car is in operation, the electromagnetic guide assembly is controlled to be in a second state, at which time the first magnetic element and the second magnetic element are separated from each other.

### BRIEF DESCRIPTION OF DRAWINGS

FIG. 1 is a schematic view of a first embodiment of an elevator of the present invention.

FIG. 2 is a schematic view of a first state of a second embodiment of an elevator of the present invention.

FIG. 3 is a schematic view of a second state of the second embodiment of the elevator of the present invention.

FIG. 4 is a schematic view of a third embodiment of an elevator of the present invention.

FIG. 5 is a schematic view of a fourth embodiment of an elevator of the present invention.

### DETAILED DESCRIPTION

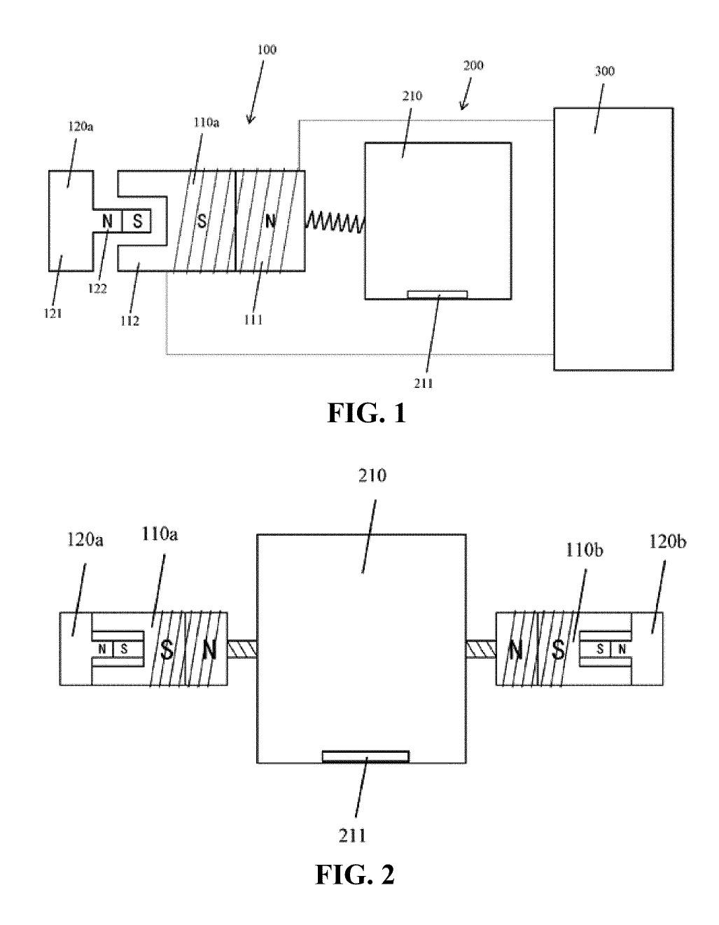

Referring to FIG. 1, a first embodiment of an elevator having an electromagnetic guide assembly is illustrated. The elevator 200 includes: an elevator liftway; an elevator car 210 arranged in the elevator liftway; and an electromagnetic guide assembly 100. The electromagnetic guide assembly includes a first magnetic element 110 connected to the elevator car 210 and a second magnetic element 120 connected to the elevator liftway. The electromagnetic guide assembly 100 comprises two states: in a first state, the first magnetic element 110 and the second magnetic element 120 abut against each other, at which time the elevator car 210 is stationary with respect to the elevator liftway; and in a second state, the first magnetic element 110 and the second magnetic element 120 are separated from each other, at which time the elevator car 210 and the elevator liftway are capable of generating a relative movement along the longitudinal direction of the elevator liftway. With this design, the frictional damage between the guide rail and the guide shoe as well as noise during the start-stop of the elevator are avoided, the start-stop vibration is reduced, the maintenance times are decreased, and comfort degree of passengers and equipment reliability are improved.

In order to realize the foregoing two states, a variety of specific designs can be made for the first magnetic element and the second magnetic element.

In terms of magnetic structure, as an example, the first magnetic element 110a is designed to be an electromagnet, while the second magnetic element 120a is designed to be a permanent magnet. More specifically, the elevator further includes a controller 300, and the controller 300 can be used to control the on-off of the circuit connecting the first magnetic element 110a. Therefore, the first magnetic element 110a and the second magnetic element 120a can be controlled to generate a repulsive force therebetween, such that in the power-on state, the first magnetic element 110a and the second magnetic element 120a can be relatively separated, thus causing the car 210 to be suspended with respect to the liftway and capable of moving up and down; and in the power-off state, the first magnetic element 110a and the second magnetic element 120a can abut against each other under the pressure exerted by external mechanical components, thus causing the car 210 to be stationary with respect to the liftway, so that passengers can enter or exit the elevator, or in case of emergency power-off, the car 210 can be suspended, to avoid falling accidents.

It should be appreciated that the above description is merely one way of implementing electromagnetic guidance, and in light of the teachings of the concept of the present invention, those skilled in the art can be inspired to implement other related ways of electromagnetic guidance to achieve the object of the present invention.

For example, by the controller 300, the first magnetic element 110a can be powered on and off in the forward and reverse directions, and then the first magnetic element 110a and the second magnetic element 120a are controlled to generate an attractive force or a repulsive force or generate no magnetic force therebetween, so as to control the movement or stop state of the elevator car 210. In one embodiment, the first magnetic element 110a and the second magnetic element 120a can be caused to generate an attractive force to suspend the elevator car 210, and the first magnetic element 110a and the second magnetic element 120a can be caused to generate a repulsive force to separate the elevator car 210 from the liftway.

For another example, the design may also be adjusted, such that the second magnetic element 120a is designed to be an electromagnet, while the first magnetic element 110a is designed to be a permanent magnet. At this time, the power-on or off of the second magnetic element 120a likewise can be controlled in a manner similar to the above, so as to control the start-stop of the elevator car.

As another example, no matter whether it is the first magnetic element 110a or the second magnetic element 120a that is designed to be an electromagnet, the on-off state of the electromagnet and the start-stop state of the elevator car 210 can be set to be controlled jointly by the controller 300; and this control will achieve the effect as follows: when the elevator car 210 is started, the electromagnetic guide assemblies 100 generate a repulsive force therebetween to separate the elevator car from the elevator liftway; and/or when the elevator car 210 is stopped, the electromagnetic guide assemblies 100 generate an attractive force therebetween to cause the elevator car to abut against the elevator liftway.

As yet another example, no matter whether it is the first magnetic element 110a or the second magnetic element 120a that is designed to be a permanent magnet, its structure can be optimized to have a metal core and a permanent magnetic surface covering the metal core, such that sufficient magnetic force can be provided while ensuring supporting strength.

In terms of mechanical structure, as an example, the first magnetic element 110 and the second magnetic element 120 can be combined into a design of a guide rail and a guide shoe in the operation guidance of the elevator car. Specifically, the first magnetic element 110 includes a first base 111 and a guide rail 112 protruding from the first base 111, and the guide rail 112 protrudes from the middle of the first base 111; and/or the second magnetic element 120 includes a second base 121 and a guide shoe 122 protruding from the second base 121, and the guide shoe 122 protrudes from both sides of the second base 121, and encloses in the middle of the second base 121 to form a guide groove for receiving the guide rail 112; wherein the guide rail 112 is arranged opposite to the guide shoe 122, and they are capable of cooperating with each other to generate a relative movement along the longitudinal direction of the elevator liftway. In practical applications, as the first magnetic element 110 is coupled to the elevator car, and the second magnetic element 120 is coupled to the elevator liftway, in the case of relative movement of the guide rail 112 and the guide shoe 122, the elevator car can move up and down with respect to the elevator liftway, thereby achieving the combination of the magnetic structure and the mechanical structure of the elevator.

In addition, as described previously, by exerting a mechanical force such as a pressure to the first magnetic element 110 and the second magnetic element 120, the abutment of the two elements can be achieved, and then can be used in cooperation with electromagnetic attractive force and repulsive force. Here is provided an example of a mechanical structure that can specifically exert a pressure. For example, the first magnetic element 110 further includes an elastic connector, and the first magnetic element is connected to the elevator car 210 via the elastic connector; wherein in the first state, the elastic connector presses the first magnetic element 110 to abut against the second magnetic element 120. Specifically, the elastic connector can be a spring sleeved inside a rigid tube, wherein an elastic force can be provided by the spring, and the relative positioning is provided by the rigid tube after the magnetic element is pressed to a specified position.

Considering that the electromagnetic guide assembly needs to be designed in conjunction with movement and stop of the elevator, a comprehensive consideration of the stability and reliability of the car movement is also necessary. In fact, in practical applications, the elevator can be configured to include multiple sets of electromagnetic guide assemblies 100; wherein all of the first magnetic elements 110 are arranged on two sidewalls of the elevator car 210, respectively, and all of the second magnetic elements 120 are arranged correspondingly on the elevator liftway; and/or all of the first magnetic elements 110 are arranged on both sides of the front wall of the elevator car 210 and the rear wall of the elevator car 210, respectively, and all of the second magnetic elements 120 are arranged correspondingly on the elevator liftway. At this time, under the cooperative force-exertion and neutralization by the multiple sets of electromagnetic guide assemblies having relative positions, the elevator can be operated and/or stopped more smoothly.

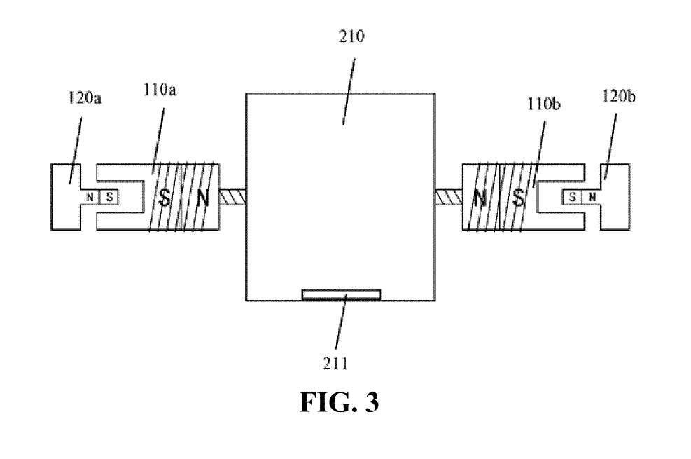

FIG. 3 shows a second embodiment of an elevator of the present invention, wherein the elevator includes two sets of electromagnetic guide assemblies 100. The first set of electromagnetic guide assemblies 110a, 120a are arranged on the left side of the elevator car 210, and the second set of electromagnetic guide assemblies 110b, 120b are arranged on the right side of the elevator car 210. Thereafter, in the second state, the first magnetic elements 110a, 110b on both sides cooperate with the second magnetic elements 120a, 120b to smoothly push the elevator car 210 together to separate it from the elevator liftway, such that it can move up and down smoothly; whereas in the first state, the first magnetic elements 110a, 110b on both sides cooperate with the second magnetic elements 120a, 120b to smoothly press the elevator car 210 together to abut it against the elevator liftway, such that it can be stopped smoothly and passengers can enter or exit freely.

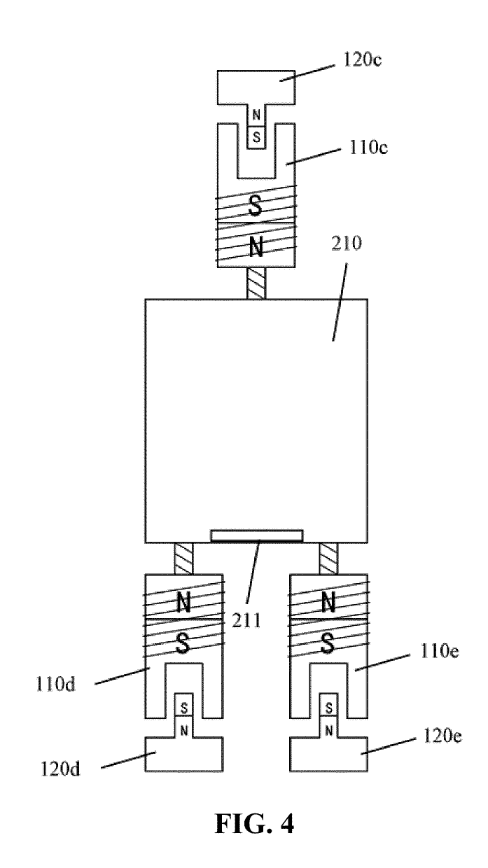

FIG. 4 shows a third embodiment of an elevator of the present invention, wherein the elevator includes three sets of electromagnetic guide assemblies 100. The third set of electromagnetic guide assemblies 110c, 120c are arranged on the rear side of the elevator car 210, and the fourth set of electromagnetic guide assemblies 110d, 120d and the fifth set of electromagnetic guide assemblies 110e, 120e are arranged on two sides of the front end of the elevator car 210, such that they can be kept away from the position of the elevator car door 211. Thereafter, in the second state, the first magnetic elements 110c, 110d, 110e on both sides cooperate with the second magnetic elements 120c, 120d, 120e to smoothly push the elevator car 210 together to separate it from the elevator liftway, such that it can move up and down smoothly; whereas in the first state, the first magnetic elements 110c, 110d, 110e on both sides cooperate with the second magnetic elements 120c, 120d, 120e to smoothly press the elevator car 210 together to abut it against the elevator liftway, such that it can be stopped smoothly and passengers can enter or exit freely.

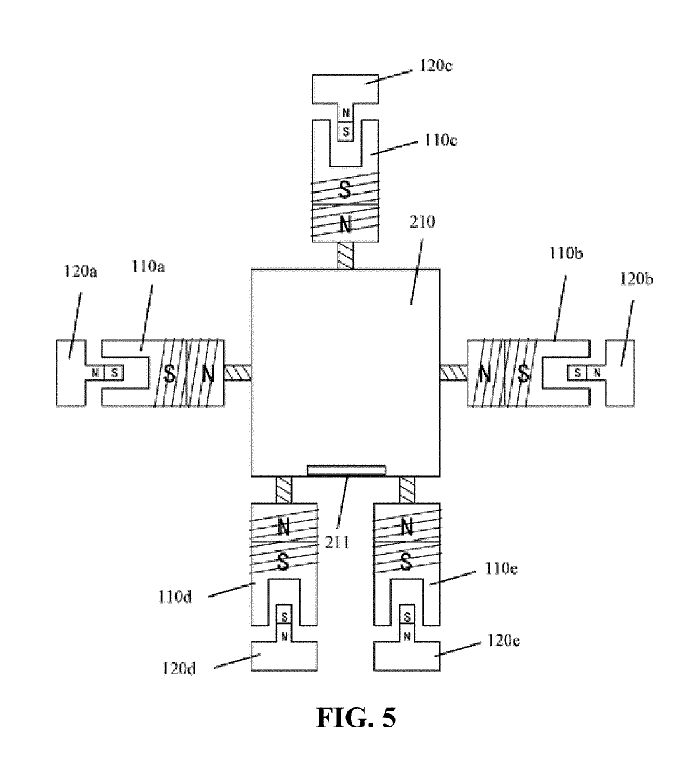

FIG. 5 shows a fourth embodiment of an elevator of the present invention, wherein the elevator includes five sets of electromagnetic guide assemblies 100, whereby the support and guidance for the elevator car are realized from four directions, respectively. The first set of electromagnetic guide assemblies 110a, 120a are arranged on the left side of the elevator car 210, the second set of electromagnetic guide assemblies 110b, 120b are arranged on the right side of the elevator car 210, the third set of electromagnetic guide assemblies 110c, 120c are arranged on the rear side of the elevator car 210, and the fourth set of electromagnetic guide assemblies 110d, 120d and the fifth set of electromagnetic guide assemblies 110e, 120e are arranged on two sides of the front end of the elevator car 210, such that they can be kept away from the position of the elevator door. Thereafter, in the second state, the first magnetic elements 110a, 110b on the two sides, the first magnetic element 110c on the rear side, and the first magnetic elements 110d, 110e on both sides of the front end cooperate with the second magnetic elements 120a, 120b on the two sides, the second magnetic element 120c on the rear side, and the second magnetic elements 120d, 120e on both sides of the front end, respectively, to more smoothly push the elevator car 210 together to separate it from the elevator liftway, such that it can move up and down more smoothly; whereas in the first state, the first magnetic elements 110a, 110b on the two sides, the first magnetic element 110c on the rear side, and the first magnetic elements 110d, 110e on both sides of the front end cooperate with the second magnetic elements 120a, 120b on the two sides, the second magnetic element 120c on the rear side, and the second magnetic elements 120d, 120e on both sides of the front end, respectively, to more smoothly press the elevator car 210 together to abut it against the elevator liftway, such that it can be stopped more smoothly and passengers can enter or exit freely.

In addition, in order to cooperate with the application of the aforementioned elevator system having the electromagnetic guide assembly, such that it can make more reasonable use of the electromagnetic functions to assist the elevator operation, here is additionally provided several embodiments of a method for controlling an elevator.

Specifically, when the elevator car 210 is stopped, the controller can control the electromagnetic guide assembly 100 to be in the first state, at which time the first magnetic element 110 and the second magnetic element 120 abut against each other, such that the elevator car 210 can be tightly engaged with the elevator liftway, and passengers can enter or exit freely; and when the elevator car 210 is in operation, the controller can control the electromagnetic guide assembly 100 to be in the second state, at which time the first magnetic element 110 and the second magnetic element 120 are separated from each other, whereby the elevator car 210 can be separated from the elevator liftway, such that the car can move freely to a target floor.

Among the above-described engagement and separation states, some of them may be realized by magnetic forces, and others may be realized by mechanical forces. For example, in the first state, the first magnetic element 110 and the second magnetic element 120 generate an attractive force therebetween to abut against each other, and/or the first magnetic element 110 and the second magnetic element 120 abut against each other under a pressure; and in the second state, the first magnetic element 110 and the second magnetic element 120 generate a repulsive force therebetween to be separated from each other.

The above examples mainly describe the electromagnetic guide assembly, the elevator and the control method thereof according to the present invention. Although only some of the embodiments of the present invention have been described, it should be understood by those of ordinary skill in the art that the present invention may be implemented in many other forms without departing from the spirit and scope thereof. Accordingly, the illustrated examples and embodiments are to be considered as illustrative rather than restrictive, and the present invention may encompass various modifications and substitutions without departing from the spirit and scope of the present invention as defined by the appended claims.

1. An electromagnetic guide assembly, comprising:
a first magnetic element for connecting to an elevator car; and
a second magnetic element for connecting to an elevator liftway;
wherein the electromagnetic guide assembly comprises two states: in a first state, the first magnetic element and the second magnetic element abut against each other; and in a second state, the first magnetic element and the second magnetic element are separated from each other, and the first magnetic element and the second magnetic element are capable of generating a relative movement along the longitudinal direction of the elevator liftway.

2. The electromagnetic guide assembly according to claim 1, further comprising a controller; wherein the first magnetic element or second magnetic element is an electromagnet and is controlled by the controller to be powered on or off.

3. The electromagnetic guide assembly according to claim 1, wherein the second magnetic element or the first magnetic element is a permanent magnet having a metal core and a permanent magnetic surface covering the metal core.

4. The electromagnetic guide assembly according to claim 1, wherein the first magnetic element comprises a first base and a guide rail protruding from the first base; and/or the second magnetic element comprises a second base and a guide shoe protruding from the second base; wherein the guide rail is arranged opposite to the guide shoe, and they are capable of cooperating with each other to generate a relative movement along the longitudinal direction of the elevator liftway.

5. The electromagnetic guide assembly according to claim 4, wherein the guide rail protrudes from the middle of the first base; and/or the guide shoe protrudes from both sides of the second base and encloses in the middle of the second base to form a guide groove for receiving the guide rail.

6. The electromagnetic guide assembly according to claim 1, wherein in the first state, the first magnetic element and the second magnetic element generate an attractive force therebetween to abut against each other, and/or the first magnetic element and the second magnetic element abut against each other under a pressure.

7. The electromagnetic guide assembly according to claim 1, wherein in the second state, the first magnetic element and the second magnetic element generate a repulsive force therebetween to be separated from each other.

8. An elevator, comprising:
an elevator liftway;
an elevator car, which is arranged in the elevator liftway; and
an electromagnetic guide assembly, which comprises a first magnetic element for connecting to the elevator car and a second magnetic element for connecting to the elevator liftway;
wherein the electromagnetic guide assembly comprises two states: in a first state, the first magnetic element and the second magnetic element abut against each other, at which time the elevator car is stationary with respect to the elevator liftway; and in a second state, the first magnetic element and the second magnetic element are separated from each other, at which time the elevator car and the elevator liftway are capable of generating a relative movement along the longitudinal direction of the elevator liftway.

9. The elevator according to claim 8, further comprising a controller; wherein the first magnetic element or the second magnetic element is an electromagnet and is controlled by the controller to be powered on or off.

10. The elevator according to claim 9, wherein when the electromagnet is powered on, the electromagnetic guide assemblies generate an attractive force or a repulsive force therebetween.

11. The elevator according to claim 9, wherein the on-off state of the electromagnet and the start-stop state of the elevator car are controlled jointly by the controller; such that when the elevator car is started, the electromagnetic guide assemblies generate a repulsive force therebetween; and/or when the elevator car is stopped, the electromagnetic guide assemblies generate an attractive force therebetween.

12. The elevator according to claim 8, wherein the second magnetic element or the first magnetic element is a permanent magnet having a metal core and a permanent magnetic surface covering the metal core.

13. The elevator according to claim 8, wherein the first magnetic element comprises a first base and a guide rail protruding from the first base; and/or the second magnetic element comprises a second base and a guide shoe protruding from the second base; wherein the guide rail is arranged opposite to the guide shoe, and they are capable of cooperating with each other to generate a relative movement along the longitudinal direction of the elevator liftway.

14. The elevator according to claim 11, wherein the guide rail protrudes from the middle of the first base; and/or the guide shoe protrudes from both sides of the second base and encloses in the middle of the second base to form a guide groove for receiving the guide rail.

15. The elevator according to claim 8, wherein
in the first state, the first magnetic element and the second magnetic element generate an attractive force therebetween to abut against each other, and/or the first magnetic element and the second magnetic element abut against each other under a pressure; and/or
in the second state, the first magnetic element and the second magnetic element generate a repulsive force therebetween to be separated from each other.

16. The elevator according to claim 15, wherein the first magnetic element further comprises an elastic connector and is connected to the elevator car via the elastic connector; wherein in the first state, the elastic connector presses the first magnetic element to abut against the second magnetic element.

17. The elevator according to claim 8, comprising multiple sets of electromagnetic guide assemblies; wherein all of the first magnetic elements are arranged on two sidewalls of the elevator car, respectively, and all of the second magnetic elements are arranged correspondingly on the elevator liftway; and/or all of the first magnetic elements are arranged on both sides of the front wall of the elevator car and the rear wall of the elevator car, respectively, and all of the second magnetic elements are arranged correspondingly on the elevator liftway.

18. A method for controlling an elevator, wherein the elevator comprises an elevator liftway, an elevator car, and an electromagnetic guide assembly, the electromagnetic guide assembly comprising a first magnetic element for connecting to the elevator car and a second magnetic element for connecting to the elevator liftway; wherein
when the elevator car is stopped, the electromagnetic guide assembly is controlled to be in a first state, at which time the first magnetic element and the second magnetic element abut against each other; and
when the elevator car is in operation, the electromagnetic guide assembly is controlled to be in a second state, at which time the first magnetic element and the second magnetic element are separated from each other.

19. The method for controlling an elevator according to claim 18, wherein in the first state, the first magnetic element and the second magnetic element generate an attractive force therebetween to abut against each other, and/or the first magnetic element and the second magnetic element abut against each other under a pressure.

20. The method for controlling an elevator according to claim 18, wherein in the second state, the first magnetic element and the second magnetic element generate a repulsive force therebetween to be separated from each other.
